(19) United States
(12) Patent Application Publication
(10) Pub. No.: US 2016/0063210 A1
(43) Pub. Date: Mar. 3, 2016

(54) SYSTEMS AND METHODS FOR ADMINISTERING HEALTH CARE SYSTEMS

(71) Applicant: Otsuka America Pharmaceutical, Inc., Rockville, MD (US)

(72) Inventors: John A. BARDI, Bethesda, MD (US); Jonathan P. ALFORD, Vienna, VA (US); James E. GRAFMYRE, Germantown, MD (US); Gillian M. CANNON, Princeton, NJ (US); John P. DOCHERTY, New York, NY (US)

(73) Assignee: Otsuka America Pharmaceutical, Inc., Rockville, MD (US)

(21) Appl. No.: 14/934,539

(22) Filed: Nov. 6, 2015

Related U.S. Application Data
(63) Continuation of application No. PCT/US2014/037345, filed on May 8, 2014.
(60) Provisional application No. 61/821,574, filed on May 9, 2013.

(51) Int. Cl. G06F 19/00; G06F 17/30; H04W 4/02

(52) U.S. Cl. CPC G06F 19/3431; G06F 19/3406; H04W 4/025; G06F 17/30312; G06F 19/3481; G06F 17/30365; G06F 19/3487; G06F 19/3418

(57) ABSTRACT

Systems and methods for healthcare system administration are described. Data may be acquired through a variety of methods and predictive analytics and indicators may be determined. Tools used may include membership cards with information concerning a consumer of healthcare services and/or an activity monitor for determining levels of activity. A caregiver check-in tool may provide additional data regarding the status of the caregiver and/or the consumer.

### CROSS-REFERENCE TO RELATED APPLICATION

This application is a continuation of International Application No. PCT/US2014/037345, filed May 8, 2014, and entitled SYSTEMS AND METHODS FOR ADMINISTERING HEALTH CARE SYSTEMS, which is non-provisional of and claims priority to and the benefit of U.S. Provisional Patent Application No. 61/821,574, filed May 9, 2013, and entitled “SYSTEMS AND METHODS FOR ADMINISTERING HEALTH CARE SYSTEMS,” which is incorporated herein by reference in its entirety.

### BACKGROUND

The present invention relates to systems and methods for using tools and procedures for system administration and, more specifically, to systems and methods for improving the accuracy and efficiency of administration systems, such as, but not limited to, mental healthcare administration systems.

In some instances, some known systems for care and monitoring of mentally ill patients are inefficient and insufficiently effective. In most jurisdictions, there is a complex interaction between government and private organizations that can lead to many individuals inadequate care and/or monitoring. The extent of government regulations and bureaucratic requirements impose an added burden on these systems that they are ill equipped to manage, thus leading to further inefficiency. Mental health care related services fall under the responsibility and operation of several different agencies, both private and public. Agencies can include behavioral health networks, the criminal justice system, healthcare providers, housing and employment providers, and many others. Interaction and communication between these agencies is often inefficient and/or non-existent. It is common for one agency to have no information regarding a consumer's interaction with another agency.

The mental healthcare system in the U.S. is fragmented, inconsistent, underfunded, and/or rapidly deteriorating. In some cases, this can allow consumers of mental health services to mentally decompensate, ultimately leading to negative crisis outcomes with serious adverse consequences for the individual and/or society. These negative outcomes can often include hospitalization, incarceration, homelessness, and/or suicide, which can, in turn, have an administrative, societal, and/or financial cost.

Mental health crises are often preventable events for an individual with mental disability, but instead often represent a combined impact of a host of other factors, including lack of access to essential services and supports, compliance with medication, poverty, unstable housing, coexisting substance abuse, untreated medical conditions, other health problems, trauma, discrimination, and/or victimization.

Thus, a need exists for improved systems and methods for using, administering, and coordinating health care systems.

### SUMMARY

Embodiments described herein solve many of the problems and/or overcome many of the drawbacks and disadvantages of at least some known systems and methods for administering health care systems. In some embodiments, the systems and methods can include a method of providing a healthcare service for any number of consumers. The method described herein includes tracking activities of the consumers and creating a set of activity data regarding the consumers. The set of activity data is stored in a database. The set of activity data of an individual consumer is stored in the database and is monitored. One or more responses are initiated when the activity data of the individual consumer includes at least one risk pattern.

In certain embodiments, the one or more responses can include providing a care plan for the individual consumer or providing information to be used for making a care plan for the individual consumer. The one or more responses can include sending a warning or a message to the individual consumer, a caregiver of the individual consumer, a practitioner of the individual consumer, and/or combinations thereof. The method can include analyzing the set of activity data and creating the at least one risk pattern that affects consumer health. The at least one risk pattern can be one of (1) a series of one or more of the activities, (2) a change of a time for one or more of the activities, and (3) a change of an activity level for one or more of the activities. The method can include tracking a status of caregivers for the consumers and creating status data of the caregivers. The activity data of the individual consumer associated with a respective caregiver and the status data of that caregiver can be shared.

The healthcare service can be metal healthcare service. The step of tracking activities can include receiving check-in data from the consumers' use of membership cards at one or more touchpoints in a community and extracting the activity data from the check-in data. The activity data can include a membership number associated with the membership card and a timestamp that shows a check-in time at the one or more touchpoints. The step of tracking activities can include receiving activity data from a consumers' use of activity monitors, wherein the activity data include an activity level indication and/or a biometric signal measurement.

Embodiments described herein can include a system for health care service membership. The system includes a server and one or more databases in communication with the server. The server executes a method including receiving check-in data from a consumer's use of a membership card at one or more touchpoints in a community. Information from the check-in data is extracted. The information is stored in the database, wherein the check-in data includes information associated with a membership number for the consumer and a timestamp.

In certain embodiments, the healthcare service is a mental healthcare service. The membership card can include information regarding the consumer's mental health.

In certain embodiments, healthcare service membership systems and methods can include receiving check-in data from a consumer's use of a membership card at one or more touchpoints in a community. Information from the check-in data is extracted and stored in a database. The check-in data includes a membership number for the consumer and a timestamp.

In certain embodiments, the healthcare service can be a mental healthcare service. The membership card can be a tap card. The membership card can include information regarding the consumer's mental health. The membership card can provide incentives to the consumer for use of the membership card. The methods and systems can identify patterns and predictive factors from the integrated data and can apply the identified patterns and predictive factors to coordinated care.

Embodiments described herein can include an activity monitor. The methods and systems can include receiving activity data from a consumer's use of an activity monitor. Activity information from the activity data can be extracted. The information from the activity data can include an activity level indication or a biometric signal measurement.

In certain embodiments, the activity data can include a timeline of consumer activity over a time period, sleep pattern information, food logging, calories burned, goal setting, and/or combinations thereof. The activity monitor can be a monitoring bracelet. The methods and systems can include determining patterns of behavior from the activity data. A report of the activity data can be provided to the consumer.

Embodiments described herein can include a caregiver check-in. Methods and systems can include providing a communication to a caregiver of a consumer; receiving caregiver check-in data from the caregiver. Caregiver status information can be extracted from the check-in data. Consumer status information can be extracted from the check-in data. The information from the check-in data can be stored.

In certain embodiments, the communication can be a text message. The caregiver check-in data can be received by text message. The communications can be provided at a random time and at a random frequency. Methods and systems can include varying the frequency of communications to the caregiver and determining patterns of behavior from the check-in data, and/or providing a report of the activity data to the caregiver.

Additional features, advantages, and/or embodiments are set forth or apparent from consideration of the following detailed description, drawings and claims. Moreover, it is to be understood that both the foregoing summary and the following detailed description are provided by way of example and are intended to provide further explanation without limiting the scope of the embodiments as claimed.

### BRIEF DESCRIPTION OF THE DRAWINGS

FIG. 1 shows an exemplary system for administration of a mental health care system according to an embodiment.

FIG. 2 shows an exemplary system for computational aspects of a mental health care system according to an embodiment.

FIG. 3 is an overview of an exemplary system according to an embodiment.

FIGS. 4A-4C show a membership card according to an embodiment.

FIG. 5 shows an exemplary check-in/check-out system according to an exemplary embodiment.

FIG. 6 shows an exemplary system for collecting and tracking information through an activity monitor according to an embodiment.

FIGS. 7-9 show exemplary systems for collecting and tracking information through a wellness check-in application each according to a different embodiment.

FIG. 10 shows an exemplary system for collecting and tracking information through a graduate check-in application according to an embodiment.

FIG. 11 shows an exemplary system for collecting and tracking information through a caregiver check-in application according to an embodiment.

### DETAILED DESCRIPTION

Systems and methods are described for using various tools and procedures for administering and coordinating medical, social, and vocational services, particularly, mental health care-related services for one or more consumers of mental health-related services. In certain embodiments, the tools and procedures can be used in conjunction with predictive analytics for system administration and coordination. The examples described herein relate to mental healthcare administration for illustrative purposes only. The systems and methods described herein can be used for many different industries and purposes, including other health care services, and/or other industries completely. In particular, the systems and methods can be used for any industry or purpose where care is administered to a number of individuals. For multi-step processes or methods, steps can be performed by one or more different parties, servers, processors, etc.

Embodiments described herein can provide short and/or long-term benefits to consumers of health care services to encourage consumers to participate. Certain embodiments can build trust by not over-reaching and demonstrating that the consumer's best interest is being considered. In certain embodiments, trusted relationships are leveraged as a starting point for initial engagement with care taken to avoid negatively impacting the trusted relationships.

In certain embodiments, multiple touchpoints can be implemented so consumers can interact with touchpoints that match their stage of recovery and willingness to participate. Embodiments described herein can integrate into existing social and contextual ecosystems to gather a full and rich picture of a consumer's state of being and provide trusted people with resources to do something with incoming information.

Embodiments described herein can provide consumers and/or individuals around the consumers to notice both minor and major deviations from routines, particularly as related to triggers and stressors for the consumer. In certain embodiments, information gathering can focus on a consumer's daily routines and stage of recovery and can focus less on a specific diagnosis.

In some embodiments, the systems and methods are described in the general context of computer program instructions and/or code stored in a memory and executed by one or more computing devices such as a processor or module that can take the form of a traditional server/desktop/laptop; mobile device such as a smartphone or tablet; or human wearable devices that monitor/store/transmit telemetry or biologic data. Computing devices typically include one or more processors coupled to data storage for storing computer program modules and/or data. Technologies of such computing devices can include, but are not limited to, the multi-industry standards of Microsoft and Linux/Unix based Operating Systems; databases such as SQL Server, Oracle, NOSQL, and DB2; Business Analytic/Intelligence tools such as SPSS, Cognos, SAS, etc.; development tools such as Java, .NET Framework (VB.NET, ASP.NET, AJAX.NET, etc.); and other e-Commerce products, computer languages, and development tools. Such program modules generally include computer program instructions such as routines, programs, objects, components, etc., for execution by the one or more processors to perform particular tasks, utilize data, data structures, and/or implement particular abstract data types. While the systems, methods, and apparatus are described in the foregoing context, processes, acts, and/or operations described hereinafter can also be implemented in hardware.

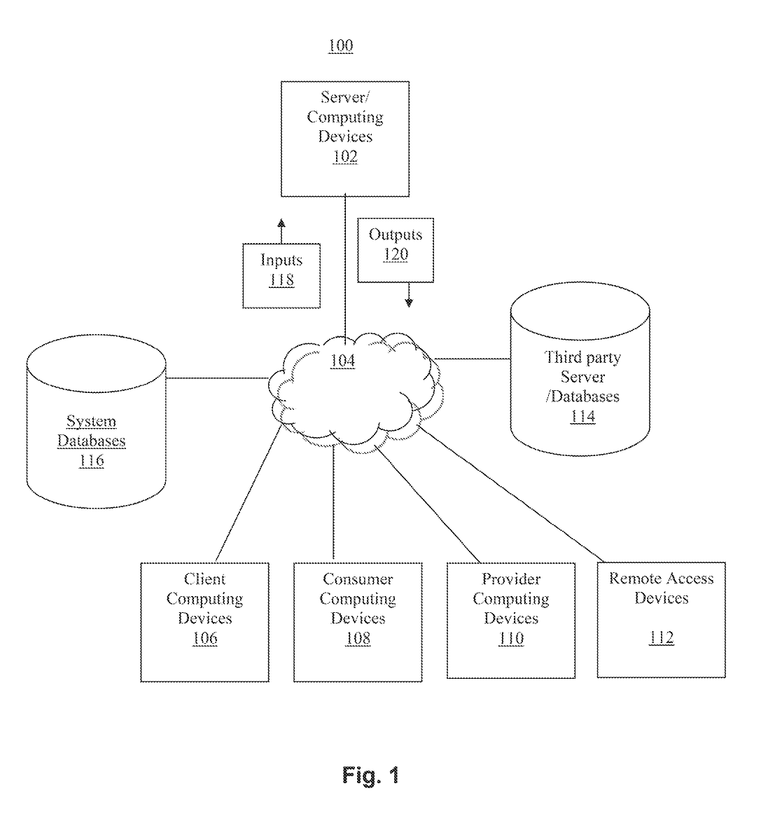

FIG. 1 shows an exemplary system 100 for using predictive analytics for system administration according to one embodiment. In this exemplary implementation, system 100 can include one or more servers/computing devices 102 (e.g., server 1, server 2 . . . server n) operatively coupled over network 104 to one or more client computing devices 106, such as one or more consumer computing devices 108, one or more provider computing devices 110, one or more remote access devices 112, etc. The one or more servers/computing devices 102 can also be operatively connected, such as over a network, to one or more third party servers/databases 114 (e.g., database 1, database 2 . . . database n). The one or more servers/computing devices 102 can also be operatively connected, such as over a network, to one or more system databases 116 (e.g., database 1, database 2 . . . database n). Various devices can be connected to the system, including, but not limited to, client computing devices 106, consumer computing devices 108, provider computing devices 110, remote access devices 112, etc. The system 100 can receive inputs 118 and outputs 120 from the various computing devices, servers, and databases, as described in further detail herein.

Server/computing device 102 can represent, for example, any one or more of a general-purpose computing device such as a server, a personal computer (PC), a laptop, a smart phone, a tablet, human wearable device, and/or so on. Networks 104 represent, for example, any combination of the Internet, local area network(s) such as an intranet, wide area network(s), cellular networks, wireless local area networks (i.e., Institute of Electrical and Electronic Engineers (IEEE) 802.11 networks known as WiFi® networks), and/or so on. Such networking environments are commonplace in offices, enterprise-wide computer networks, etc. Client computing devices 106, which can include at least one processor, represent a set of arbitrary computing devices executing application(s) that respectively send data inputs to server/computing device 102 and/or receive data outputs from server/computing device 102. Such computing devices include, for example, one or more desktop computers, laptops, mobile computing devices (e.g., tablets, smart phones, human wearable device), server computers, and/or so on. In this implementation, the input data comprises, for example, requests, physiological data, mental health data, observation data, audio, video, geolocation information, customer information, data files, dates, and/or so on, for processing with server/computing device 102. In one implementation, the data outputs include, for example, emails, templates, forms, and/or so on. Some embodiments described herein can also be used for collaborative projects with multiple users logging in and performing various operations on a data project from various locations. Embodiments described herein can be web-based, smart phone-based and/or tablet-based or human wearable device based.

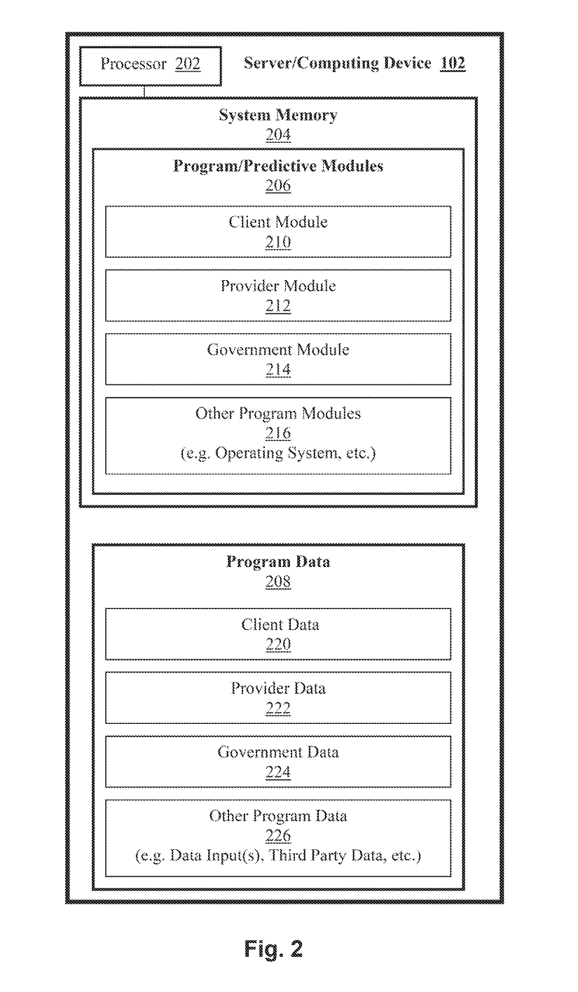

As shown in FIG. 2, in this exemplary implementation, server/computing device 102 includes at least one processor 202 coupled to a system memory 204. System memory 204 can include computer program instructions, code, modules, and/or data. For example, the system memory 204 can include a program and/or predictive analysis engine, module(s), and/or system. More specifically, as shown in FIG. 2, the system member 204 can include predictive modules 206 which can include, for example, a client module 210, a provider module 212, a government module 214, and other program modules 216 configured to execute and/or include instructions for an operating system and/or the like.

In some embodiments, one or more users can interact with the system. The processor 202 and/or memory 204 can be used to run and/or operate the system and memory described herein. The one or more users can be divided into categories that include, but are not limited to, consumers and/or clients, care providers, government officials, system administrators, etc. In this manner, the system memory 204 and/or any other portion of the server 102 can store and/or include, for example, program data 208 such as client data 220, provider data 222, government data 224, and/or other program data 226 (see e.g., FIG. 2). Furthermore, program data 208 can be stored in the system member 204, system databases 116, and/or in third party server databases 114 (see e.g., FIGS. 1 and 2). As such, the client module 210 can be configured to perform one or more processes or the like associated with the client data 220, the provider module 212 can be configured to perform one or more processes or the like associated with the provider data 222, the government module 214 can be configured to perform one or more processes or the like associated with the government data 224, and the other program modules 216 can be configured to perform one or more processes or the like associated with the other program data 226.

In some embodiments, one or more users can sign up to use and/or enroll in the system. Sign up can be via website, mobile app, telephone registration, paper forms, etc. The sign up information provided by the user can include contact information, such as, but not limited to, email address, mailing address, phone numbers, and other identifying information. Based upon the sign up information, the users can be assigned to categories of users and can be granted corresponding privileges within the system. For example, the privileges can be distinct between a consumer user and a care provider. The category of user can also determine what information is available on the system website.

Data can be acquired through a variety of means and predictive analytics and indicators can be determined. The predictive analytics and indicators can be used to provide a care plan for one or more individuals. As shown in FIG. 2, predictive analytics can be an overarching module or can be incorporated into sub-modules. Predictive analytics can integrate with data inputs and outputs of the system to provide data, recommendations, and improvements. The predictive analytics and indicators can be applied to information tracked regarding the one or more individuals. The predictive analytics and indicators can be updated based on information gathered regarding the care plan implementation for the one or more individuals.

Embodiments described herein can allow for a comprehensive data collection process and/or the creation and enhancement of predictive analytics. A comprehensive data collection process can integrate data from disparate data sources (e.g., justice system, medical/healthcare system, social/welfare system, financial management systems, etc.). The collection process can be varied (e.g., caregiver input, community input, patient input using web interfaces, near/far field sensors, paper files/forms, biometric measures, and electronic devices, etc.). The development and/or enhancement of the predictive analytics can use application of standard events and mathematical and simulations, models, methodologies, algorithms to analyze the data to inform better clinical/social/economic decision making, individualized treatment planning, crisis intervention and systems management, etc.

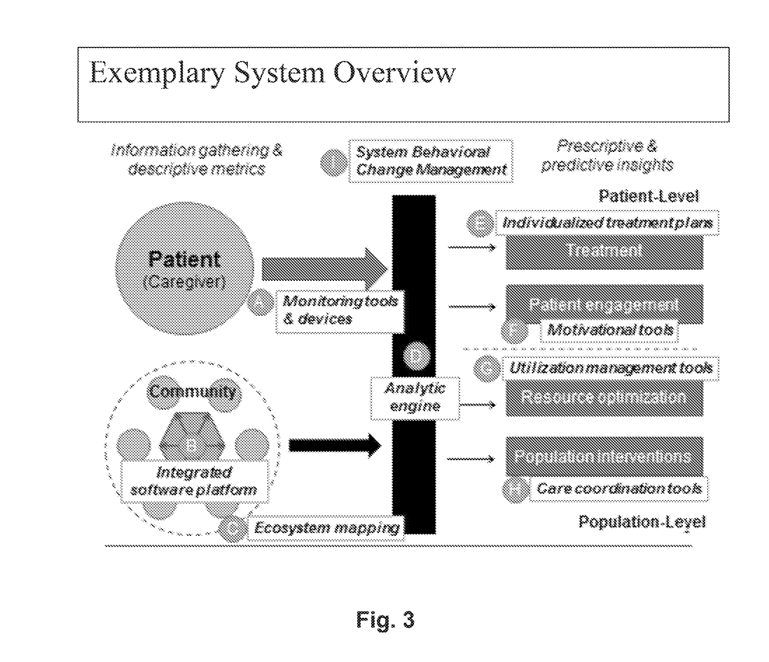

FIG. 3 is an overview of an exemplary system according to an embodiment. The following is a description of the background and at least some embodiments of elements found in FIG. 3.

### A. Monitoring Tools and Devices

Provider knowledge of an individual's physical, mental, and emotional state is often limited to the individual's health state and self-reported account during discrete periods of interaction. Monitoring tools seek to enhance both the individual's (and/or his/her caregiver's) and the providers' awareness of the individual's state on a more continuous basis through passive or self-reported monitoring of physical, cognitive and emotional metrics.

These metrics can be stored and/or transmitted to the provider as-is and/or processed to enhance interpretation (e.g., data visualization, alerts). The enhanced knowledge provided can facilitate a variety of benefits, including, but not limited to, more accurate diagnosis, more consistent delivery of care, timely feedback on treatment response, improved medication dosing and early intervention to prevent deterioration.

Monitoring tools and devices can include but are not limited to:
Medication compliance/adherence tracking devices
Cognitive function tests and remediation interventions
Sleep pattern monitoring
Dietary monitoring
Physical activity monitoring
Stress monitoring (e.g., verbal)
Blood glucose monitoring
Heart rate monitoring
Facial expression monitoring
Mood assessment tools
Hormone and other chemical monitoring

These inputs can be incorporated into a user interface that interacts with an integrated software platform (described in Section B below) and that can be enhanced with patient engagement features (described in Section F below).

### B. Integrated Software Platform

Centralized collection, storage and sharing of data across multiple points of entry, and from diverse and multiple relevant sources, which can include, but are not limited to, the individual, his/her caregivers, health care providers, other service providers (e.g., caseworkers, housing facilities), payers, law enforcement and judicial authorities, can be a prerequisite for improved monitoring of an individual's health status and planning his/her care.

Additionally, the centralization of data not specific to individuals is often useful to support the overall system, such as by facilitating payments and contracts between institutional users. A unified software platform such as, for example, the embodiments described herein can greatly facilitate this data centralization.

In some embodiments, such a software platform can enable collection and sharing of data elements including, but not limited to:
Identification
Health status
Other individual circumstances (e.g., transportation, employment, availability of caregivers and other support structures)
Health care services (e.g., diagnosis, treatment, medication) and associated costs
Other services (e.g., housing) and associated costs

The software platform can be equipped with access controls to ensure compliance with relevant privacy statutes. The software platform can be equipped with tools to enhance usability and interpretability of the information, including rule-based alerts and recommendations and data visualization tools.

### C. Ecosystem Mapping

An understanding of the cause and effect relationships that influence the movement of people, not limited to patients, and resources, including financial, can, for example, enhance the effective implementation of the other elements contained in the described framework, as well as potential unmet needs and intervention points. In some instances, an ecosystem map can act as a learning tool to facilitate aspects including software design, resource allocation and establishment of analytical hypotheses, as well as engaging users in the implementation process.

The robustness of the described understanding can be verified and enhanced through the calibration of a mathematical model based upon actual or modeled data inputs. For example, in some embodiments, a system dynamics or agent-based (or hybrid) model can be used to define a mapping of the system, as well as individual components of the ecosystem, and provide scenario planning through simulations for current and future states of the ecosystem.

### D. Analytics Engine

Information on individuals collected via monitoring and/or provider inputs can enable users to make decisions based on standard operating procedures and/or the “mental models” they have formed from their own education and/or experience. The collected data, however, can also enable decision-support tools based on clinically and financially relevant data that might not otherwise be available and aggregate insights derived from analyzing data on a larger collection of individuals, who can be from within the same system and/or from a larger population.

Data analysis can be descriptive, prescriptive and/or predictive, and can be used for a variety of purposes:
Descriptive: Create charts or other representations showing users the current treatments (e.g., medication) that is most frequently used for others with characteristics similar to a given individual;
Prescriptive: Create individualized treatment plans (as described in Section E below);
Predictive: Identify individuals who are high risk of becoming non-compliant with their medication, highlight candidates for intervention (as described in Section H below).

A wide variety of analyses can be used as appropriate, including, but are not limited to:
Patient segmentation (e.g., predictive clustering, tree algorithms, machine learning algorithms, etc.).
Health outcomes analysis.
Regression analysis.
Gap analysis.

### E. Individualized Treatment Plans

Prescriptive insights derived from the analytical engine described above can be used to enable a plan-approved guidance for care by facilitating the ability to create specific action plans for the treatment of a given individual. Existing guidance, such as best practice guidelines, authorized treatment protocols, reimbursement policies, can be incorporated. These insights can provide decision support to providers and professional caregivers, who can apply them in accordance with their professional knowledge and familiarity with the individual case. Reporting systems can be enabled, in which providers can justify deviations from the recommended treatment protocol.

The creation of the treatment plan can be an iterative process, with the caregiver providing feedback and the analytical engine responding accordingly, e.g., if an individual did not respond well to the medication that the analysis initially suggested, the system could respond with the next best option.

The elements of the individual treatment plan can include, but are not limited to:
Type of treatment received (e.g., intensive case management vs. assertive community treatment).
Medication, including dosing, administration and schedule.
Type of provider/professional caregiver interactions (e.g., via telemedicine as described in Section F below).
Appointment frequency.

### F. Tools for Patient Engagement

To support the type of individual monitoring described above, while simultaneously preserving the individual's autonomy to decide what is best for his/her health, the individual can, for example, be sufficiently motivated to perform any task(s) to support that monitoring. Caregivers can also be engaged in this process.

Moreover, one limitation associated with conducting analysis on an individual's health status is the difficulty of attributing meaning to an individual “disappearing” from the provider network's “radar.” Such “drop-offs” often support one of three different conclusions; either the individual is sufficiently well that he or she has little or no need to see a care provider, or the individual is sufficiently unwell that he or she lacks the desire or the ability to seek out care. Another potential reason is that the individual can lack the financial resources to pay for care.

To best identify those individuals in the “off the radar” population who might benefit from further intervention, it is desirable to engage individuals on a more ongoing basis to gain visibility into their health state.

A further type of patient engagement can reduce the barriers to entry for obtaining care. For example, many individuals often lack access to transportation to and from appointments, or encounter language or cultural barriers in interacting with providers. Remote interaction with providers and/or interaction with avatars calibrated to the individual's cultural or language preferences could ease some of the obstacles.

At a more basic level of engagement, at least some of the framework described here can be premised on the ability to identify individuals consistently and over time, which can be challenging in a population which can be reluctant to provide real identities due to concerns such as social stigmas associated with illness, immigration status, and/or criminal history. Identification tools, therefore, can be designed to maximize willingness to use them in the process of receiving care.

Monitoring devices and tools can be enhanced with additional features to promote their use by the intended individuals. Such enhancements can include, but are not limited to:
“Gamification” that would allow them to cooperate with or compete against others, or against their own or others' expectations;
Rewards systems that might allow them to redeem credits received for items of monetary or symbolic value.

Additional motivational tools that can be linked with or independent of monitoring tools can include:
Internet-based social networks that can provide encouragement and moral support to individuals struggling with health issues;
Alert system for caregivers and providers to allow them to provide encouragement for the patient (tying in to Section H below).
The organization of community-based activities that provide visibility into an individual's whereabouts and status, as well as offering potential independent therapeutic benefit, including support groups, athletic activities and volunteer opportunities.

In some instances, such functionality is premised on the observance of applicable privacy and confidentiality requirements.

In some instances, “iVisits” can allow an individual to interact with a provider electronically (if the individual has access to the technological means). The interaction can be with an actual person, an actual person via an avatar, or an automated avatar.

Consumer identification tools can include specially designed identity cards that enhance an individual's sense of “personhood” and consequently increase his/her willingness to use them to ease identity verification by care providers.

### G. Utilization Management Tools

Service providers have an ongoing need to monitor the types of services they are providing and to whom they are providing the services, and typically, providers have standard reporting requirements to funding sources such as state governments. Service providers can also attempt to deploy limited resources in the most cost effective and socially responsible way.

Data elements that can be collected for utilization management can be customizable based on local/payer reporting requirements and can include, but are not limited to:
Patient identity.
Patient insurance status and financial means.
Patient housing/employment status.
Services provided.
Resources used/available (e.g., beds)

The information collected can be used to create tools facilitating processes such as:
Service authorization.
Claims adjudication.

The data elements can also be used to calculate aggregate statistics, including:
Number of individuals served.
Resource utilization and waitlists.
Re-admissions
Days of stay.
Distribution of services by level or intensity of care.
Other performance measures.

### H. Care Coordination Tools

As noted with individualized treatment plans above, to some extent the act of sharing information can enable caregivers to provide better-coordinated care. Data collection and analysis can further enable the coordination of care beyond this simple transparency by proactively identifying the movement of an individual from one location to another. Best-practice protocols can then be applied to maximize the chance that the transition will go smoothly.

Similarly, data analysis as described above can help identify when a patient can be transitioning from one health state to another (which can coincide with his/her physical movement between institutions, domiciles or treatments). Protocols for intervention in the event of a deterioration of status can then be devised.

Further, data collection and analysis can help ensure the consistent conduct of a unified treatment plan when a patient changes providers or sites of care.

Examples of transitions/events that can be flagged to providers to, for example, trigger additional support can include:
Hospital/crisis stabilization unit to home care/outpatient facility or residential facility.
Judicial system/incarceration to home care/outpatient facility or residential facility.
Juvenile healthcare/justice system to adult healthcare/justice system (18th birthday).
Deterioration of health state as indicated by monitoring devices, caregiver input, appointment/medication noncompliance, etc.
Significant individual events that have been previously identified during provision of care (e.g., planned departure of caregiver, anniversary of a spouse's death).
Changes in financial status that preclude care through the individual's usual channels and can require him/her to be connected to other resources.

Examples of tools and protocols for ensuring proper coordination of care for transitioning individuals or those identified as needing services from more than one provider can include, but are not limited to:
Data dashboards, including automated alert systems.
Discharge/intake checklists.
Alerts/policies requiring verification of successful arrival of individual from one provider to another, and follow-up if unsuccessful.
Alerts/policies requiring follow-up for missed appointments.
Notifications when prescriptions go unfilled have potential for negative interactions with individual's other medications.

### I. Behavioral Change Management

In some instances, for the system described above to operate effectively, it can be desirable to have many stakeholders can require support the system. In addition to patient engagement, it can also be desirable to engage all users to ensure the accurate collection of the data and the implementation of the individual action plans and coordinated care.

Although conceptually straightforward, this is often an element to ensuring success of the system and, in some instances, can be vulnerable to failure. It can be desirable, therefore, to maintain stakeholders buy-in throughout the process, initially via communication of the goals of the system and the steps necessary to achieve them and subsequently, via the communication of the ongoing progress toward the attainment of those goals to remain committed to its success.

Ease of use of the software platform (as described in Section B) can, in some instances, ensure user satisfaction with the system.

Possible activities to support change management include, but are not limited to:
Workshops and motivational sessions.
Training and coaching sessions.
Presentation of results.
User satisfaction surveys.

As indicated, several tools and procedures can be employed for improving a health care system. A mental health care system is used for illustrative purposes, but other types of systems are contemplated.

### Membership Card

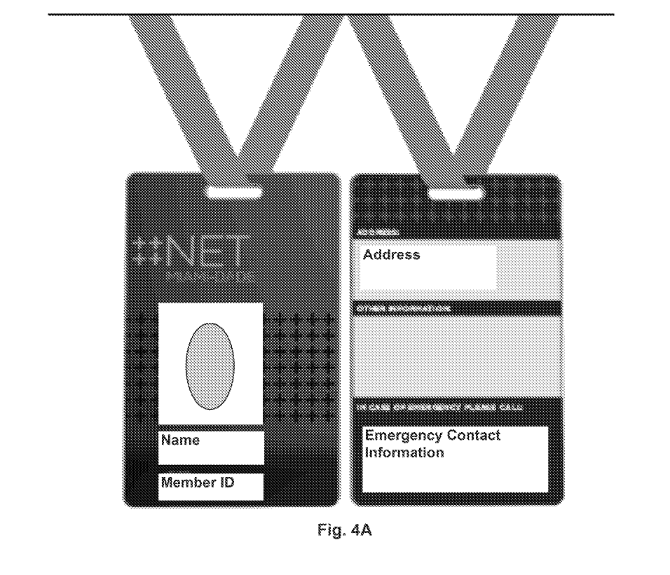

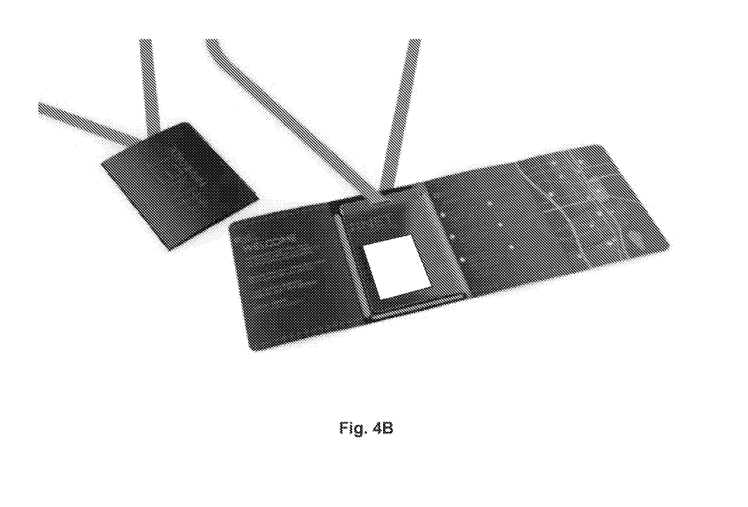

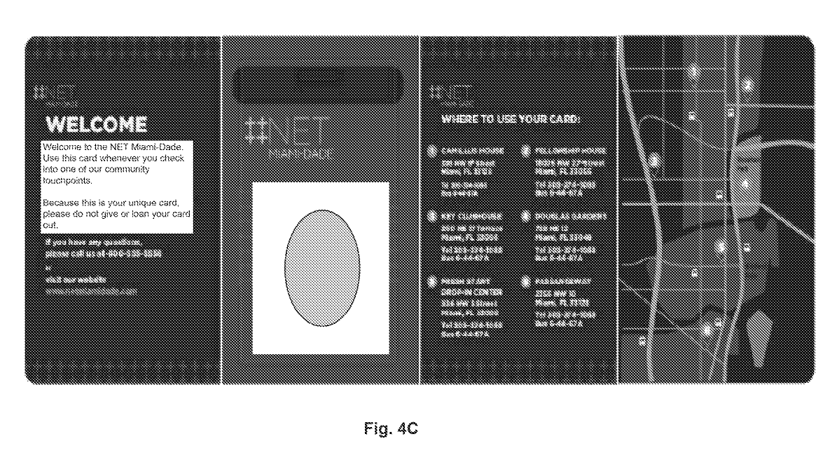

Embodiments described herein can collect and track information through a membership card, establish patterns of behaviors to predict early crisis, provide means of identification and access to services, etc. As shown in FIGS. 4A-4C, a membership card can be any device and/or system that is associated with a consumer. For example, a membership card can be carried by a consumer to check-in/check-out at medical and/or non-medical community touchpoints. In alternative embodiments, the membership card can be virtual, can be a smartphone, a radio frequency identification (RFID), a near field communication (NFC) tag, etc. The card can identify the consumer as a member of the medical and/or non-medical community Check in can be limited to locations where participation in an activity occurs. For example, a consumer can check in to group therapy at a supportive housing, but cannot check in to supportive housing as a residential unit.

The card itself can have various components. For example, the card can include and/or contain a photo of the consumer, membership number, address, emergency contact information, phone numbers for medical providers, phone numbers for administrators of the system, etc. The card may include a wallet, which may be a pocket sized wrap plan, traditional wallet, lanyard-hanging device, or any other portable device. The wallet may be waterproof. In certain embodiments, the locations where the card may be used are printed on the card and/or within a card wallet. Locations may include, but are not limited to, assisted living facilities, crisis centers, medical centers, hospitals, community centers, clubhouses, transportation providers, etc. The wallet may include additional information such as available mental health resources, medication information, instructions for using the card, and/or blank space for notes.

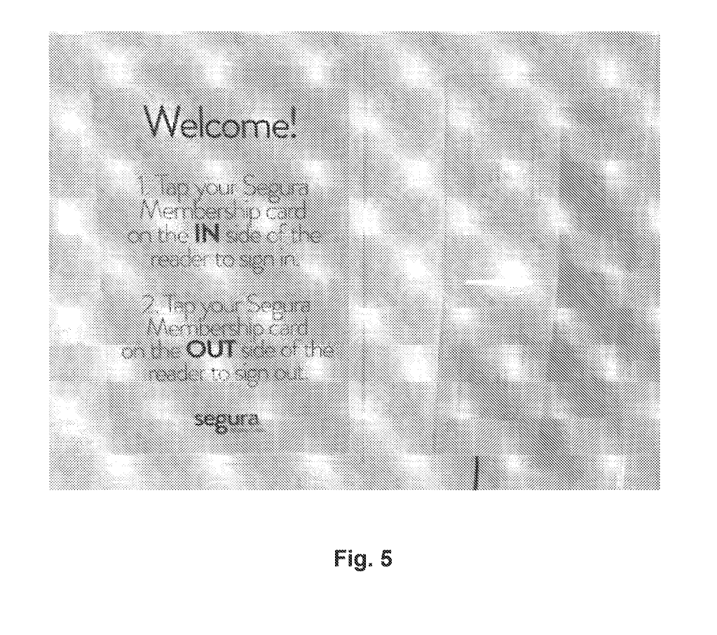

Touchpoints may have swipe (e.g., magnetic), biometric, such as fingerprint recognition, retina recognition, facial recognition, etc., near field reading capability, or other access capabilities for use with the card. A consumer may swipe or tap the card to check in/out. The card described herein may interact with existing systems and procedures at touchpoints. The additional information can be utilized by the touchpoints. The information may be digitized and/or time/date stamped upon check in/out. Data captured may include membership ID, location, time, date, etc. See FIG. 5 for an example of a check-in/out device.

The card and information on the card may be linked directly or indirectly to the administration system. Tracking and other information may be transmitted to the administration system where the results may be stored, processed and/or analyzed.

In certain embodiments, the card may also include a tracking device, such as a GPS system. The real-time location of a consumer may be tracked and/or a record of the consumer's location may be processed, stored, and/or analyzed. The card may also have other interconnectivity to community touchpoints (e.g. public transportation access/services, local vendors, etc.). System administrators may be able to see an attendance list for a location and/or a given consumer. Administrators may manually check-in a consumer that may not have a membership card or may have lost or forgotten a membership card.

One or more incentives may be generated for the consumer by using the card, such as coupons or points for attendance. Reporting may be provided for the consumer.

In some instances, being a member of, for example, a system such as those described herein can have mental health benefits for a consumer. For example, a membership can confer a sense of belonging and status. Furthermore, many consumers do not have an identification (ID) card with a photo, which would be useful when dealing with police and/or others. The membership card may or may not be considered legal identification in various embodiments described herein. Tracking of information through the card may provide information regarding individual consumer attendance patterns, adherence to treatment plans, and mobility within the system. Aggregated data may provide information regarding resource utilization.

### Activity Monitor

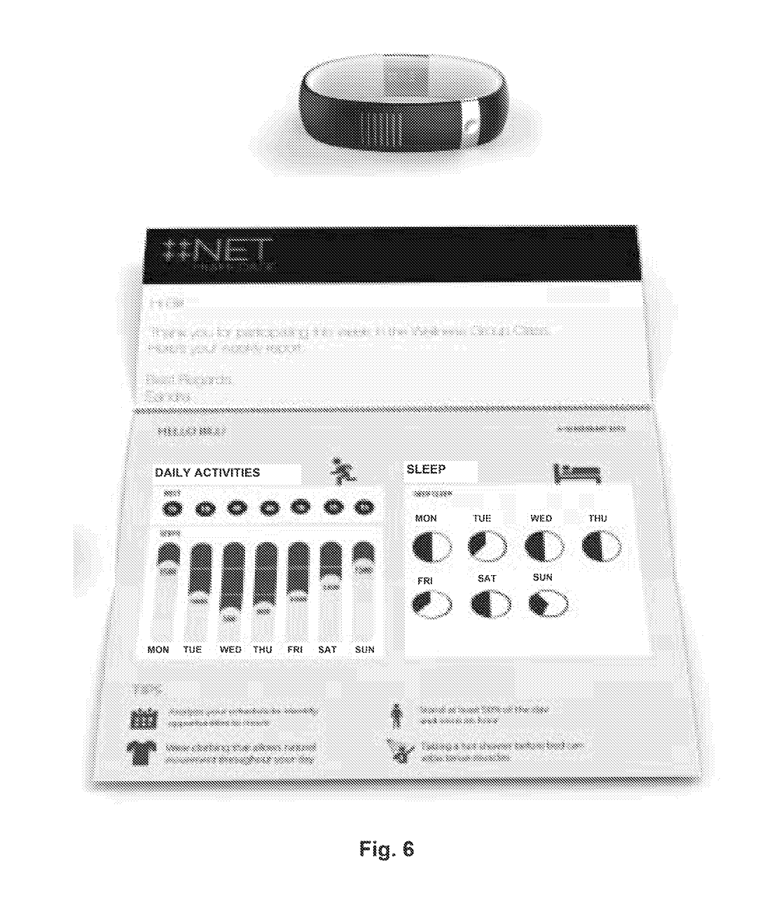

Embodiments described herein may collect and track information through an activity monitor. As shown in FIG. 6, an activity monitor may be a device that is far field or one worn by a user to track general activity level and a corresponding report may be generated. Devices already exist that capture pieces of information (e.g. NIKE FUELBAND, FITBIT FLEX, JAWBONE UP), but do not capture holistic information pertaining to mental health consumers. Additional collection devices may include input from digestible devices and adhesive/dermal sensors. Certain embodiments may include mental health specific functionality, as well as an application-programming interface (API) to import data into the system. Functionality of the devices may be associated with a device, such as hard wired, or may be programmed into existing devices. Activity, sleep and/or other biometric data, such as heart rate, blood pressure, temperature, etc., may be captured. The report may include name, membership number, time reviewed, daily activities, sleep, tips, instructions, etc. Activity monitors may be used for consumers to determine meaningful data patterns and/or deviations from such data patterns to better inform decisions (e.g. clinical, social, and economic). Consumers may also be able to wear a bracelet or other activity-monitoring device, and not be prone to losing or loaning items. The activity monitor may be a long-term item or may be used during key transition periods for the consumer. Activity and/or inactivity may be related to overall well-being and changes in activity may be predictive of a pattern towards decompensation.

Data may be captured from the activity monitor at one or more touchpoints in the mental healthcare system. Status of activities may be displayed in non-judgmental colors. Consumers can be mailed activity logs on a regular basis showing their data and/or logs may be printed out at community touchpoints, and may even be part of a wellness program at a community touchpoint.

Higher functioning and engaged consumers may benefit from a more advanced device that includes features such as food logging, calories burned, heart rate patterns, sleep and activity patterns, goal setting, etc. In some embodiments, the activity monitor may be connected to a computer to access one or more advanced features. Consumers with an advanced device may be able to go online and track progress (e.g., via a web browser and the Internet).

### Wellness Check-in

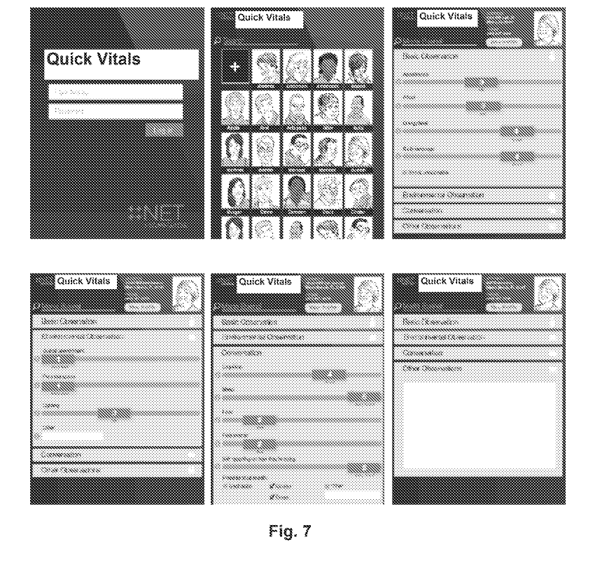

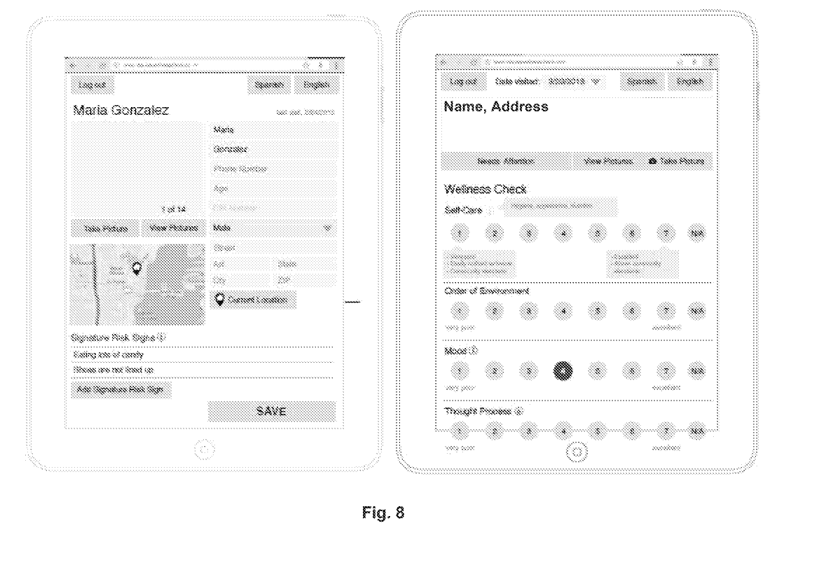

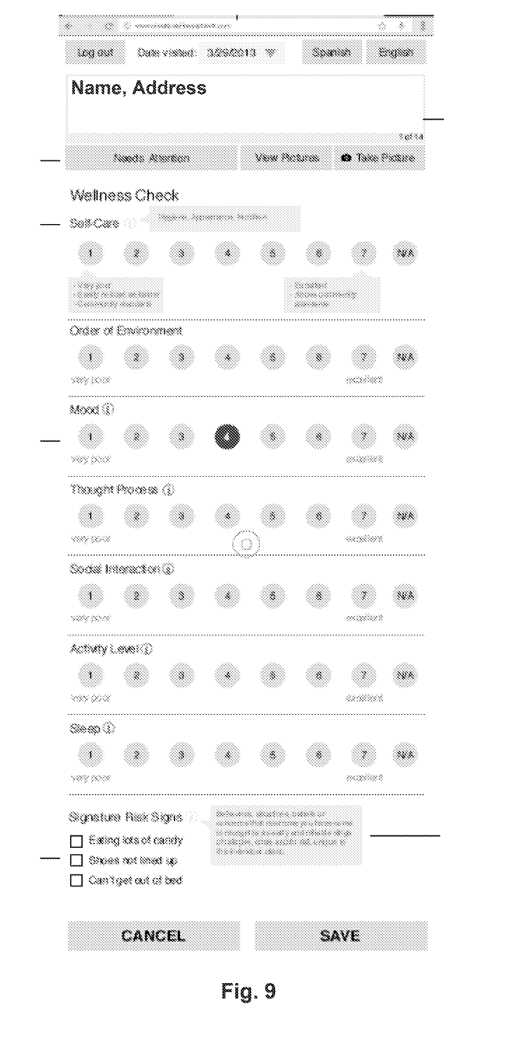

Embodiments described herein may collect and track information through a wellness check-in application. As shown in FIG. 7, an application for a smart phone, computer, tablet, etc. may provide an interface and reporting to allow professionals to document a quick assessment of consumers based on observable qualities of the consumer and their environment, as well as additional information gained in conversation with the consumer. FIGS. 8 and 9 show alternative embodiments of a wellness check-in system, each according to different embodiments.

A professional may have a list of consumers for which the professional is responsible, but may also have access to some or all consumers within the system. In certain embodiments, the professional's consumers may be listed first or in a separate section. In certain embodiments, consumer information may be searchable by consumer name, identification number, etc. Each consumer may have a wellness check-in history available to the professional.

The wellness check-in tool may support a variety of use cases where the breadth of the data may vary. For example, a quick vital assessment by a professional may be observational of the consumer, but an assessment on a home visit may involve observation of the consumer, their environment, and also information gathered from conversation with the consumer. Observational information may be a numerical indication on a predetermined scale and/or may include a short description of the consumer, such as a few words to a few sentences in length provided by the professional.

Embodiments described herein may streamline existing processes of notes. Attributes evaluated may include hygiene, affect, cognition, clinical state and environmental conditions, mood, activity level, consumer self-reported data on sleep, overall wellbeing, etc. Collection of these attributes may establish data patterns and analytics may be used to identify breaks in the data patterns as flags for possible decomposition events. Flags may be provided for potential issues with medications, drugs, alcohol, etc. A free form text area may be provided for additional notes or observations.

Certain embodiments may also include individual profile information, such as triggers. Consumers may be allowed to add and/or share plans or other individualized fields. Shared data may be used across touchpoints to give context to any professional interacting with the consumer.

### Graduate Check-in

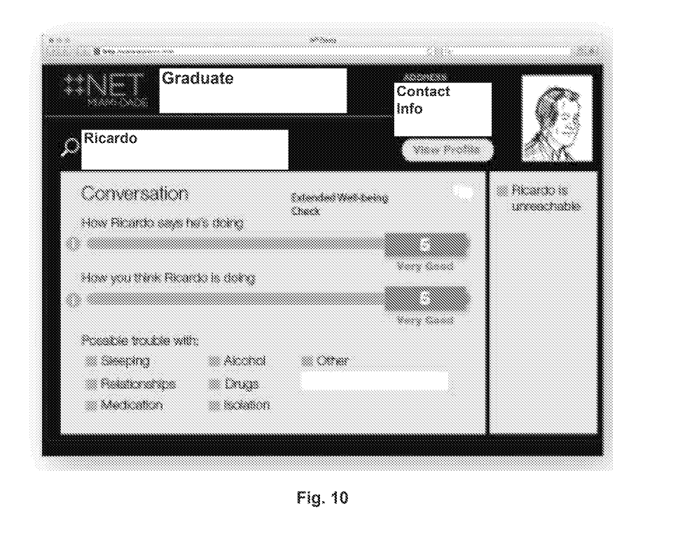

Embodiments described herein may collect and track information through a graduate check-in application. As shown in FIG. 10, an application for a smart phone, computer, tablet, human-wearable device, etc. may provide an interface and reporting regarding a graduate of a formal program or completion of a formal treatment plan. A consumer may select a profession with whom they had a close relationship and together they may decide a frequency with which they will check back with each other over a set time in person, by phone, etc. The graduate check-in tool may assist a professional in managing a list of graduates with one or more calendar reminders about when to communicate with a graduate. The professional can either report that all is okay or note any early warning signs, such as through check boxes, that are determined based on knowledge of the consumer. The professional may also make an assessment of when the consumer should be contacted again.

### Caregiver Check-in

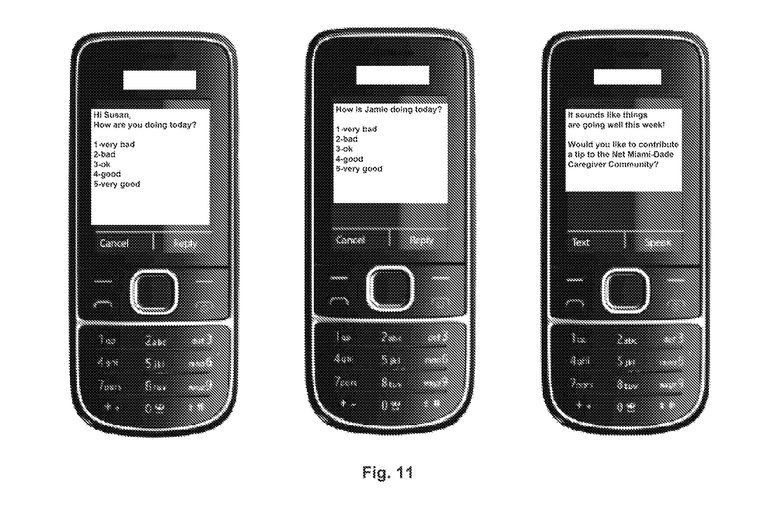

Embodiments described herein may collect and track information through a caregiver check-in application. As shown in FIG. 11, an application for a smart phone, computer, tablet, human-wearable device, etc. may provide an interface and reporting of caregiver self-reporting. In certain embodiments, a text system may be provided. In other embodiments, phone calls, emails, etc. may be provided. In certain embodiments, the caregiver may get a recorded voice or text message from a trusted individual. For purposes of the following description, text messages are described, but other forms of communication are contemplated.

The text system may capture how a caregiver is doing and also how they think the consumer is doing. Text messages may be sent to a mobile device of the caregiver asking for a rating. Text messages may allow for asynchronous responses and may be less disruptive. The text messages may be sent on a regular, but unpredictable basis. After a rating of the caregiver and consumer are provided by the caregiver, a context sensitive message may be sent. If the scores indicate that both the caregiver and the consumer are doing well, a certain message may be sent. If scores are low and indicate that one or both of the caregiver or the consumer are not doing well, additional questions and/or information about additional help may be sent.

Users may receive texts at unpredictable intervals to make it less likely they will be ignored and to sample different times and days of the week. Frequency of texts may be dynamic based on length of participation in the system and specific ratings and rating trends for the caregiver and the consumer. With texts sent several times a week, the questions may focus on overall daily coping. If over time the caregiver continually rates himself or herself and the consumer stable or doing well, the frequency of texts may decrease. As frequency decreases, the questions may change to match the time frame, such as “How is the consumer doing this week?” If the caregiver starts rating themselves or the consumer as dong less well, the frequency of texts may increase or the question may change. Multiple languages may be supported.

Paper reports and/or electronic copies of reports may be provided to the caregiver on a regular basis. Reports may include visualization of both their scores and their report on the consumer's scores, tips from the administration system, information on free and/or upcoming community events, a signed letter for a stronger emotional connection to the community, or other information.

The data captured by the systems described herein may be transmitted, stored, processed or otherwise analyzed. For example, possible patterns may be detected and noted. A communication may provide results of the analysis to professionals, the caregiver and/or the consumer.

In certain embodiments, the caregiver check-in may provide follow-up. For example, a response system may be provided where caregivers are provided an opportunity to ask questions or the system may provide additional information on sources for help, etc.

Although the foregoing description is directed to certain embodiments, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field programmable gate array (FPGA), and/or an application specific integrated circuit (ASIC). Software modules (executed on hardware) can be expressed in a variety of software languages (e.g., computer code), including C, C++, Java™ Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, and not limitation. Where schematics and/or embodiments described above indicate certain components arranged in certain orientations or positions, the arrangement of components may be modified. While the embodiments have been particularly shown and described, it will be understood that various changes in form and details may be made. Although various embodiments have been described as having particular features and/or combinations of components, other embodiments are possible having a combination of any features and/or components from any of embodiments as discussed above.

Where methods and/or events described above indicate certain events and/or procedures occurring in certain order, the ordering of certain events and/or procedures may be modified. Additionally, certain events and/or procedures may be performed concurrently in a parallel process when possible, as well as performed sequentially as described above.

What is claimed is:

1. A method of providing health care service for a plurality of consumers, the method comprising:
tracking activities of the plurality of consumers;
defining a set of activity data regarding the plurality of consumers;
storing the set of activity data in a database;
monitoring activity data of a consumer from the plurality of consumers stored in the database; and
initiating one or more responses when the activity data of the consumer from the plurality of consumers includes at least one risk pattern associated with a health of the consumer.

2. The method of claim 1, wherein the one or more responses includes providing at least one of a care plan for the consumer from the plurality of consumers or information to be used for defining a care plan for the consumer from the plurality of consumers.

3. The method of claim 1, wherein the one or more responses includes sending a warning or a message to at least one of the consumer from the plurality of consumers, a caregiver associated with the consumer from the plurality of consumers, or a practitioner associated with the consumer from the plurality of consumers.

4. The method of claim 1, further comprising:
analyzing the set of activity data; and
defining the at least one risk pattern that affects consumer health.

5. The method of claim 1, wherein the at least one risk pattern is one of (1) a series of one or more of the activities, (2) a change of a time for one or more of the activities, or (3) a change of an activity level for one or more of the activities.

6. The method of claim 1, further comprising:
tracking a status of caregivers associated with each consumer from the plurality of consumers;
defining status data for each of the caregivers;
sending the activity data of the consumer from the plurality of consumers to an associated caregiver; and
sending the status data of the associated caregiver to the consumer from the plurality of consumers.

7. The method of claim 1, wherein the health care service is metal health care service.

8. The method of claim 1, wherein the tracking activities of the plurality of consumers includes:
receiving check-in data from the use of a membership card associated with each consumer from the plurality of consumers at one or more touchpoints in a community; and
extracting the activity data from the check-in data, the activity data including at least a membership number associated with the membership card and a timestamp associated with a check-in time at the one or more touchpoints.

9. The method of claim 1, wherein the tracking activities of the plurality of consumers includes:
receiving activity data from an activity monitor associated with each consumer from the plurality of consumers, the activity data including at least one of an activity level indication or a biometric signal measurement.

10. A system for using health care service membership, the system comprising:
a server including at least a processor and a memory, the server being in communication with a database,
the server configured to:
receive check-in data from a membership card associated with a consumer, the membership card operative in identifying the consumer at one or more touchpoints in a community;
extract information from the check-in data;
store the information from the check-in data in the database, the information from the check-in data including at least a membership number associated with the consumer and a timestamp; and
identify, based on the information from the check-in data, at least one of a consumer activity pattern, an adherence to a treatment plan associated with the consumer, a consumer mobility, or a resource utilization.

11. The system of claim 10, wherein the health care service is a mental health care service.

12. The system of claim 11, wherein the information extracted from the check-data from the membership card includes information regarding the consumer's mental health.

13. The system of claim 10, wherein the membership card is at least one of a magnetic tap card, a radio frequency identification card, or a near field communication card.

14. The system of claim 10, wherein the server is configured to associate one or more incentives with the consumer based at least partially on a use of the membership card.

15. The system of claim 10, wherein the server is configured to coordinate care based at least in part on identifying the at least one of a consumer activity pattern, an adherence to a treatment plan associated with the consumer, a consumer mobility, or resource utilization.

16. A system for monitoring activity of a consumer in a health care service, the system comprising:
a server including at least a processor and a memory, the server being in communication with a database,
the server configured to:
receive activity data from an activity monitor associated with the consumer, the activity monitor operative in tracking an activity of the consumer;
extract activity information from the activity data;
store the information from the activity data in the database, the information from the activity data including at least an activity level indication or a biometric signal measurement associated with the consumer; and
identify, based on the information from the activity data, at least one of a consumer activity pattern or a deviation for the consumer activity pattern.

17. The system of claim 16, wherein the information from the activity data associated with the consumer includes at least one of a time line of consumer activity over a time period, sleep pattern information, food logging, calories burned, heart rate, blood pressure, or goal setting.

18. The system of claim 16, wherein the activity monitor is a monitoring bracelet.

19. The system of claim 16, wherein the server is configured to provide a report of the information from the activity data to the consumer or a caregiver associated with the consumer.

20. A system for providing a health care service, the system comprising:
a server including at least a processor and a memory, the server being in communication with a database,
the server configured to:
send a communication to a caregiver associated with a consumer;
receive caregiver check-in data associated with the caregiver;
determine caregiver status information from the caregiver check-in data;
store the caregiver status information from the caregiver check-in data in the database;
receive consumer check-in data associated with the consumer;
determine consumer status information from the consumer check-in data;
store the consumer status information from the consumer check-in data in the database; and
associate the caregiver status information from the caregiver check-in data with the consumer status information from the consumer check-in data.

21. The system of claim 20, wherein the communication sent to the caregiver is via a short message service message.

22. The system of claim 20, wherein the caregiver check-in data is received via short message service message.

23. The system of claim 20, wherein the communication sent to the caregiver is at a random time.

24. The system of claim 20, wherein the server is configured to send a plurality of communications to the caregiver, the plurality of communications being sent to the caregiver with a varying frequency over a time period.

25. The system of claim 20, wherein the server is configured to determine patterns of behavior associated with the caregiver based on the caregiver status information from the caregiver check-in data and determine patterns of behavior associated with the consumer based on the consumer status information from the consumer check-in data.

26. The system of claim 25, wherein the server is configured to send a report to the caregiver, the report at least partially based on at least one of the patterns of behavior associated with the caregiver or the patterns of behavior associated with the consumer.
